(19) United States
(12) Patent Application Publication
(10) Pub. No.: US 2008/0064551 A1
(43) Pub. Date: Mar. 13, 2008

(54) Control Method For A Transmission Device Between A Heat Engine Shaft And An Axle Shaft Of A Vehicle

(75) Inventors: Jacques Laeuffer, Paris (FR); Sebastien Besnard, Sceaux (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy-Villacoublay (FR)

(21) Appl. No.: 11/575,943

(22) PCT Filed: Sep. 20, 2005
(86) PCT No.: PCT/FR05/50764

§ 371 Date: Mar. 23, 2007

(30) Foreign Application Priority Data
Sep. 24, 2004 (FR) 0452158

(51) Int. Cl. F16H 3/72

(52) U.S. Cl. 475/5

(57) ABSTRACT

The invention essentially relates to a method of controlling a device (1) for the transmission of power between a shaft (2) of a heat engine (3) and an axle shaft (4). The inventive method involves the use of two electric machines (6, 7), namely a first machine having a rotation speed WA and a torque CA and a second machine having a rotation speed WB and a torque CB. A coupling device (11) comprises an electric controller (27) which produces set point signals RefCA and RefCB for controlling the inverters (12, 13). According to the invention, in order to produce set point signals RefCA and RefCB, an electric reference signal RefELEC corresponding to CA*WA+CB*WB and a mechanical reference signal RefMECA corresponding to CA*WB−CB*W A are applied at the inputs of the control device.

The present invention concerns a regulation method for a power transmission device between a shaft of a heat engine and a shaft of wheels of a vehicle. A goal of the present invention is to make such a method more stable and more precise. The present invention has a particularly advantageous application in the field of motor vehicles, but it could also be implemented in trains, boats, or motorcycles.

Power transmission devices between a shaft of an engine and a wheel shaft used in hybrid vehicles are known. Such devices are described in the application FR-A-2832357. These transmission devices have generally a heat engine, and a pair of electric machines. The shaft of the engine, the shaft of the wheels, and shafts of the machines are connected with one another via a mechanical assembly. The two machines are connected with each other via an electrical connection device including in particular an electric bus. These machines operate as motors or as generators as a function of the electrical and mechanical powers applied to their shafts and their terminals, respectively.

Power supplied by the heat engine can be, either transmitted directly to the wheels via a mechanical chain comprising in particular the mechanical assembly, or derived in an electric chain including electric machines and the connection device. The power derived into the electric chain is transmitted to the shaft of the wheels so as to adjust the torque applied to this shaft, and to adapt the torque and the speed of the heat engine to an operating point where its consumption is minimal. Adjusting the torque applied to the shaft of the wheels provides a high driving comfort, whereas adapting the torque and the speed of the engine makes it possible to save energy.

In the case where a high-capacity storage system is connected to the bus, the two machines have numerous degrees of freedom. Indeed, these machines can operate, for example, both as motors in a power-boost phase, or both as generators in battery storage phases.

In the case where no high-capacity storage system is connected to the bus, all the power supplied by one of the machines into the electric chain is instantaneously consumed by the other machine. The algebraic sum of the mechanical powers of the two electric machines is thus quasi-zero. Indeed, this power corresponds simply to the losses of the electric machines and to a power intended for an on-board network of the vehicle. To ensure a balance between the powers supplied by the two electric machines, a capacitor is connected to connections of the electric bus. This capacitor is a storage system of low capacity as compared to the high-capacity storage system mentioned previously.

A method of electrical regulation for transmission devices that do not have a high-capacity storage system is known. This method described in the application EP-1174304 is based on a regulation of a voltage observable at the terminals of the capacitor. Indeed, the fact that the balance of the electrical powers in the electric chain must be zero translates into a constant voltage at the terminals of the capacitor.

Thus, in this electrical regulation system, a first inverter associated with a first machine is controlled so that a given torque is applied to the shaft of this first machine. The voltage at the terminals of the capacitor is then measured and compared to a threshold voltage value. If the voltage observable at the terminals of the capacitor is different from the threshold voltage, then a second inverter associated with the second machine is driven in order to bring the voltage at the terminals of the capacitor back to the threshold voltage.

In practice, when the voltage measured at the terminals of the capacitor is more than the threshold voltage, the second inverter can be controlled in several ways. More precisely, when the second machine operates as a motor, the second inverter is controlled by a control device, so that the second machine converts more electrical power into mechanical power. When the second electric machine operates as a generator, the inverter is controlled so that the second machine converts less mechanical power into electrical power. Of course, if the voltage observable at the terminals of the capacitor is less than the threshold voltage, the second inverter is controlled in the reverse manner.

Such a regulation is relatively stable and has a very short response time, in the order of the hundred microseconds. This type of regulation is often combined with a so-called mechanical type regulation method.

In this mechanical regulation method, it has been imagined that for a change of speed of the heat engine, the electric machines were going to be controlled so that this heat engine operates most of the time at its optimal operating point. Optimal operating point means an operating point where the speed and the torque of the engine correspond, for a given power, to a minimal consumption of the heat engine.

For such a regulation method, a stabilized torque to which the heat engine positions itself to supply a given power is lower, in the order of 30 percent, than the maximum torque of this engine. During an acceleration of the vehicle, an additional power can thus be obtained quickly by acting on the fuel supply of the heat engine. This acceleration takes place without interruption in the torque applied to the shaft of the wheels of the vehicle.

In this mechanical regulation method, two conditions must be verified permanently. Thus, the torque applied downstream of a flywheel connected to the shaft of the engine must always be less than the stabilized torque. An object of this first condition is not to suffocate the engine. In addition, the torque applied to the shaft of the wheels must always be less than a set point torque. An object of this second condition is not to race the engine. To each condition is associated a closed regulation loop. Depending on the condition that is met, the mechanical regulation chain switches from one loop to another. This switching causes a lack of precision in the application of the torque to the shaft of the wheels. Indeed, during a switching, since the value of the torque to be compared to a reference torque is modified, a variation of the torque applied to the shaft of the wheels can be observed. It can even happen that the mechanical regulation chain diverges.

The present invention proposes to solve this precision problem of the mechanical regulation chain.

To this effect, in the invention, a mechanical reference signal is produced that is intimately linked to an electrical reference signal. Then, by combining values of this electrical reference signal and values of this mechanical reference signal, set point torques to be applied to the shafts of the two electric machines are determined.

More precisely, in the invention, an electrical reference signal is produced from an electrical regulation chain. And a mechanical reference signal is produced from a mechanical reference chain. This mechanical regulation chain uses in particular as parameter values of expected reference torques on the wheels and on the shaft of the engine. Values of these reference signals are combined in a system of two equations with two unknowns that is solved. The values found correspond to the expected set point torques on the shafts of the electric machines.

In accordance with the invention, in a given space, a straight line associated with the mechanical reference signal is preferably perpendicular to a straight line associated with the electrical reference signal. Having two perpendicular straight lines makes it possible to limit the divergence of the regulation chain and to make it more precise. The coordinates of the intersection point of the straight lines correspond to the set point torques expected on the shafts of the electric machines.

In addition, the mechanical reference signal is obtained with the help of an open regulation loop. This open regulation loop makes the mechanical regulation method more stable than the known method which implements closed loops.

Thus, the invention concerns a regulation method for a power transmission device between a shaft of a heat engine and a shaft of wheels, this method implementing

two electric machine, a first machine having a shaft rotation speed WA and a torque CA, a second machine having a shaft rotation speed WB and a torque CB,

a mechanical assembly connecting the shaft of the wheels, the shaft of the engine and the shafts of the two electric machines with one another,

a linking device ensuring a direct passage of an electrical power between the two machines,

the linking device having an electrical regulation device producing set point signals RefCA and RefCB intended to be followed by the two machines,

characterized by

producing an electrical reference signal RefELEC corresponding to CA*WA+CB*WB and applying it to a first input of the electrical regulation device, and

producing a mechanical reference signal RefMECA corresponding to CA*WB−CB*WA and applying it to a second input of the electrical regulation device, and

with the regulation device, producing set point signals RefCA and RefCB by linear combination of the electrical reference signal RefELEC and of the mechanical reference signal RefMECA.

The invention will be better understood by reading the following description and examining the accompanying Figures. These Figures are provided by way of illustration but absolutely not limitation of the invention. These Figures show:

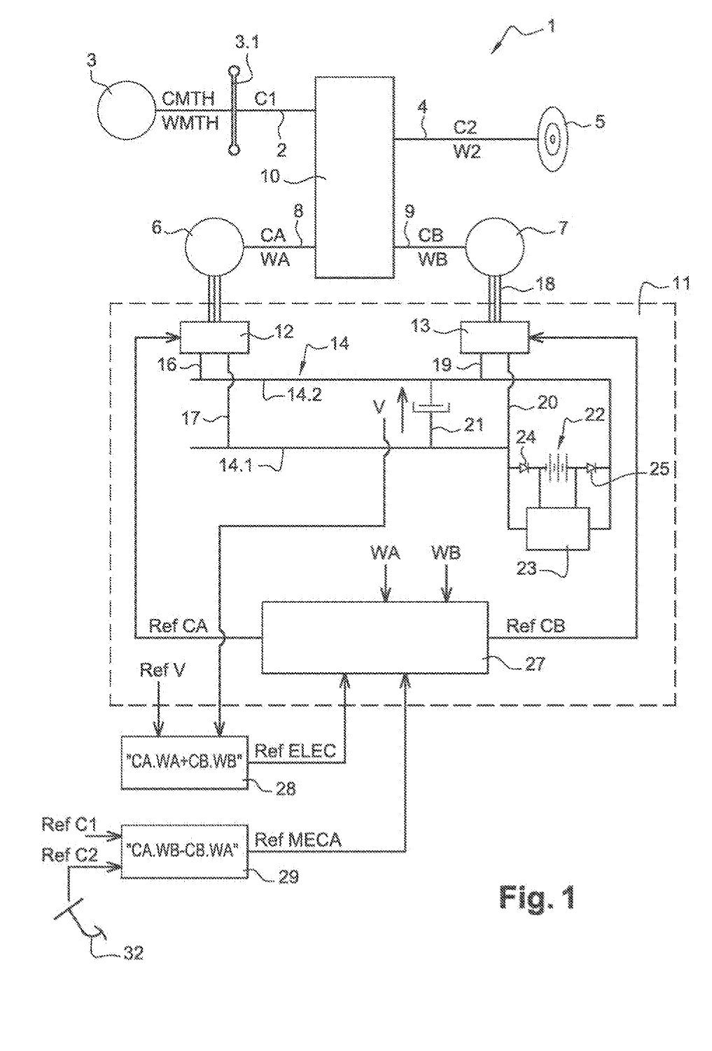

FIG. 1: a schematic view of a power transmission device implementing the method according to the invention;

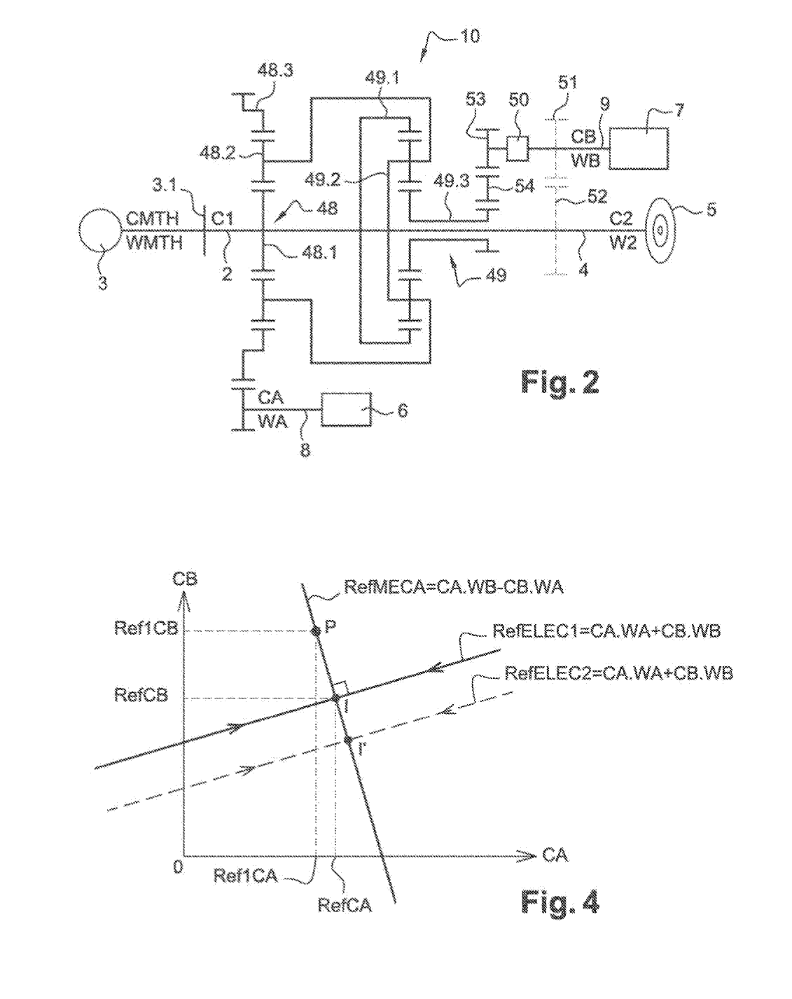

FIG. 2: a schematic view of a mechanical assembly connecting a shaft of a heat engine, shafts of electric machines, and a shaft of wheels with one another;

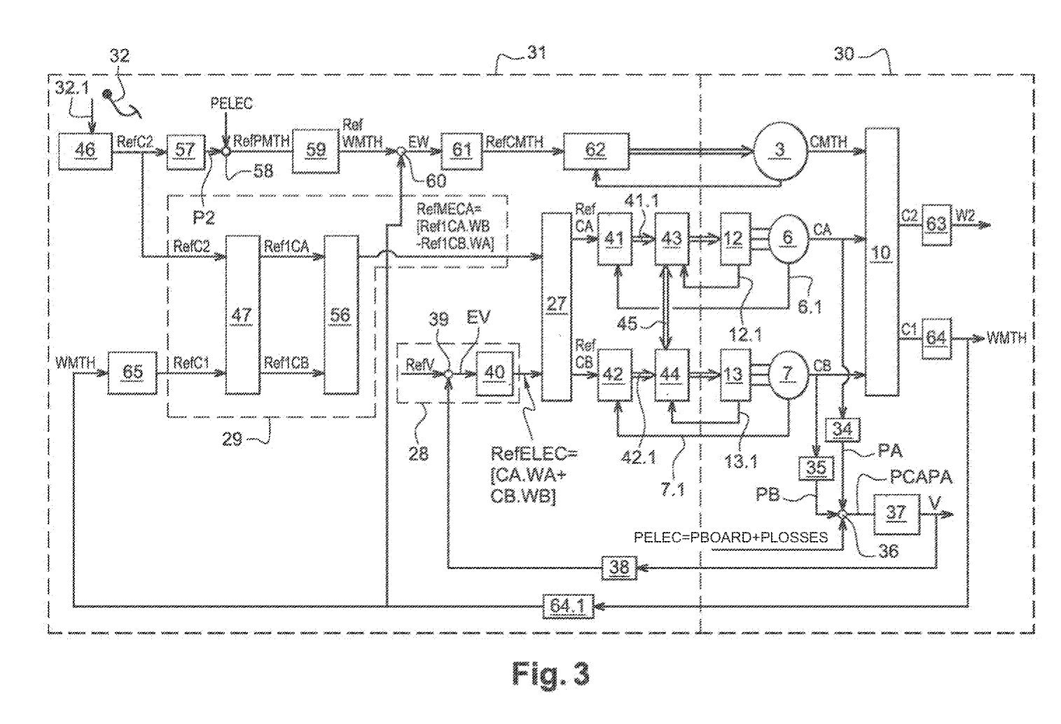

FIG. 3: a schematic view of a regulation system implementing the method according to the invention;

FIG. 4: a graphic view of an adjustment of the reference torques expected on the shafts of the electric machines, obtained by using the method according to the invention.

FIG. 1 shows a schematic view of a power transmission device 1 between a shaft 2 of an engine 3 and a shaft 4 of wheels 5 of the vehicle. This device 1 has a first electric machine 6 and a second electric machine 7. The shaft 2 of the heat engine 3, the shaft 4 of the wheels 5, and shafts 8 and 9 of the machines 6 and 7 are connected with one another via a mechanical assembly 10.

A linking device 11 connects the two machines 6 and 7 with each other. This linking device has in particular two inverters 12 and 13 and a direct current bus 14. This bus 14 has a first, negative connection 14.1 and a second, positive connection 14.2. More precisely, phases 15 of the first machine 6 are connected to the inverter 12 which is itself connected to the two connections of the bus 14 via two wire connections 16 and 17. Phases 18 of the second machine 7 are connected to the inverter 13 which is itself connected to the bus 14 via wire connections 19 and 20.

A flywheel 3.1 is coupled to the shaft 2 of the engine 3. A torque CMTH is observable upstream of the flywheel 3.1 on the shaft 2. And a torque C1 is observable downstream of this flywheel 3.1 on the shaft 2. This shaft 2 has a shaft rotation speed WMTH. The shaft 4 of the wheels 5 has a rotation speed W2 and a torque C2 which is observable on this shaft 4. The shaft 8 of the first machine 6 has a rotation speed WA and an electromagnetic torque CA. The shaft 9 of the second machine 7 has a rotation speed WB and an electromagnetic torque CB.

There is a balance between the powers produced and consumed by the engine 3 and the machines 6 and 7 of the transmission device 1. Thus, all these torques and these rotation speeds satisfy equations characteristic of the mechanical assembly 10. These equations are called transmission equations and will be given in the description of FIG. 2.

A portion of the power produced by the engine 3 can be transmitted directly to the shaft 4 of the wheels 5 via a mechanical chain comprising the mechanical assembly 10. A portion of this power can also be derived into an electric chain having the electrical connection and the two machines 6 and 7.

In this embodiment, no high-capacity storage system is connected to the bus 14. Power produced by one of the machines 6 or 7 is thus automatically consumed by the other machine. Thus, when one of the machines 6 or 7 operates as a motor, the other machine operates as a generator.

When one of the machines 6 or 7 operates as a generator, the inverter 12 or 13 associated thereto transforms AC voltage signals observable at the terminals of the coils of the machine into a DC voltage signal observable on the bus 14. The transistors of the inverter 12 or 13 are then often blocked, so that freewheel diodes connecting each an emitter and a collector of a transistor form a diode bridge.

When one of the machines 6 or 7 operates as a motor, the inverter 12 or 13 associated thereto transforms the DC voltage observable on the bus 14 into dephased AC voltage signals which are applied to the terminals of the coils of the machine 6 or 7. The inverters 12 and 13 are controlled so as to vary the intensity and the frequency of the current passing through the coils of the machine 6 or 7 associated thereto. The intensity of the current passing through the coils of the machine is connected to the intensity of the torque produced by this machine; whereas the frequency of the current passing through the coils of the machine is connected to the rotation speed of the shaft of this machine.

In practice, the machines 6 and 7 used are triphased electric machines of the synchronous type. These machines are interesting because they are compact and have a good output.

A low-capacity storage system, such as a capacitor 21, is connected between the two connections 14.1 and 14.2 of the bus 14. This storage system is called low-capacity by opposition to the previously stated high-capacity storage system. The high-capacity storage system can be connected to the bus 14 and store an amount of power sufficient to participate in the adjustment of the torque applied to the shaft 4 of the wheels 5. In contrast, the capacitor 21 makes it possible to ensure simply a balancing of power between the machines 6 and 7. This balancing takes place when voltage variations are observable on the bus 14. A voltage V is measurable at the terminals of the capacitor 21. As a variant, the low-capacity storage device 21 is a small, low-capacity battery. As a variant, no low-capacity storage device 21 is connected between the connections 14.1 and 14.2 of the bus 14.

Preferably, a service battery 22 is connected to the bus 14 via a converter 23. At the terminals of this battery 22, a voltage is observable that is much lower than the voltage observable on the bus 14. This service battery 22 supplies an extra power to the machines 6 and 7. This extra power makes it possible to start the engine without the help of a starter. The converter 23 makes it possible to transform the high DC voltage observable on the bus 14 into a low DC voltage to re-load the service battery 22.

A first and a second diodes 24 and 25 are connected to the bus 14 so as to protect the service battery 22 from the high voltage observable on the bus 14. More precisely, an anode of the first diode 24 is connected to the negative connection 14.1 of the bus 14; whereas a cathode of the first diode 24 is connected to a negative terminal of the battery 22. An anode of the second diode 25 is connected to a positive terminal of the battery 22; whereas a cathode of this second diode 25 is connected to the positive connection 14.2 of the bus 14.

In addition, the connection device 11 has a regulation module 27 that makes it possible to regulate the values of the torques CA and CB observable on the shaft of the first machine 6 and on the shaft of the second machine 7, respectively. To this effect, an electrical reference signal RefELEC and a mechanical reference signal RefMECA stem, as will be seen on FIG. 3, from an electrical regulation loop and a mechanical regulation loop, respectively. These reference signals RefELEC and RefMECA are emitted on a first input and a second input, respectively, of the regulation device 27.

From these signals RefELEC and RefMECA, this regulation device 27 emits set point signals called RefCA and RefCB. These set point signals RefCA and RefCB control the inverters 12 and 13, respectively, so that currents passing through the coils of the machines 6 and 7 generate set point torques on the shafts 8 and 9 of the machines.

More precisely, the electrical reference signal RefELEC corresponds to CA*WA+CB*WB and the mechanical reference signal corresponds to CA*WB−CB*WA. The set point signals RefCA and RefCB are produced by linear combination of the electrical reference signal RefELEC and of the mechanical reference signal RefMECA, with the help of the regulation device 27. The electrical reference signal RefELEC corresponds to the electrical power dissipated in the electric chain. This electrical reference signal RefELEC is produced from the voltage signal V observable at the terminals of the capacitor 21. As we have seen, this voltage signal V is compared to a threshold voltage signal RefV in an electrical regulation loop.

The mechanical reference signal refMECA is obtained by simulation from a reference signal RefC1 and a reference signal RefC2. The reference signal RefC1 corresponds to the torque expected on the shaft 2 downstream of the flywheel 3.1. The reference signal RefC2 corresponds to the torque expected on the shaft 4 of the wheels 5.

In a particular embodiment, the voltage signal V and the threshold voltage signal RefV are applied to a first input and a second input, respectively, of a first regulation module 28. The electrical reference signal RefELEC is observable at the output of this first regulation module 28. The reference signals RefC1 and RefC2 are applied each to an input of a second regulation module 28. The mechanical reference signal RefMECA is observable at the output of this second regulation module 29.

In addition, signals WA and WB are applied to a third and a fourth inputs, respectively, of the device 27. These signals WA and WB correspond to the rotation speed of the shaft 8 of the first machine 6 and to the rotation speed of the shaft 9 of the second machine 7, respectively.

During the processing time of the reference signals RefELEC and RefMECA, the values of the rotation speeds WA and WB are considered as fixed. Indeed, the shafts 8 and 9 have an inertia and the duration necessary for a change in their rotation speed is much longer than the response time of the electrical regulation loop.

Inside the regulation device 27, two equations are entered:
RefELEC=CA*WA+CB*WB (1)
RefMECA=CA*WB−CB*WA (2)

The coefficients WA and WB are fixed and RefELEC and RefMECA are entered as data. From the equations (1) and (2), CA and CB, which are in fact RefCA and RefCB, can thus be determined.

If the formatting of the equations is modified, the following can be established
CB=(−WA/WB)*CA−refELEC/WB (1)
CB=(WB/WA)*CA−refMECA/WA (2)

If a referential is considered in which CB is indicated in ordinate and CA in abscissa, these equations (1) and (2) correspond to equations of two affine straight lines that are perpendicular with respect to each other. Indeed, the slopes WB/WA and −WA/WB of the straight lines associated with these two equations (1) and (2) are opposed and inversed with respect to each other. The system formed by the equations (1) and (2) has thus always a solution. The fact that there is always a solution makes the regulation of the values of the torques CA and CB to apply to the shafts of the two machines 6 and 7 particularly stable. The set point signals RefCA and RefCB will indeed always be capable of being produced.

Further, the fact that the two straight lines are perpendicular enables the regulation of the torques CA and CB to be more precise. Indeed, it will be seen on FIG. 4 that, for a variation of the value of the electrical reference signal RefELEC, the values of the set point signals RefCA and RefCB vary only little with respect to the values of the previous set point signals RefCA and RefCB.

As a variant, the equations (1) and (2) are associated with two straight lines that cross and form any angle with each other.

The electric bus 14 constitutes more generally an electrical connection connecting the two inverters 12 and 13 with each other. By the way, these two inverters 12 and 13 constitute, more generally, transmitting devices that transmit or remove power to the electric machines 6 and 7. In a variant of the invention, the electrical connection 14 is a triphased voltage bus that connects the transmitting devices. In this variant, the transmitting devices take the form of switches controlled by the reference signals RefCA and RefCB.

FIG. 2 shows a schematic view of the mechanical assembly 10 according to the invention. Its study is necessary for the understanding of the transmission equations that are associated thereto. As will be seen on FIG. 3, these transmission equations are used in the implementation of the method according to the invention.

The mechanical assembly 10 is formed by a first planetary train 48 and a second planetary train 49. The trains 48 and 49 have each a sun gear, a planet carrier and a ring gear which mesh mutually. In this embodiment, the sun gear 48.1 of the first planetary train 48 is connected to the ring gear 49.1 of the second train 49 and the planet carrier 48.2 of the first train 48 is connected to the planet carrier 49.2 of the second train 49. The shaft 2 of the engine 3 is connected to the sun gear 48.1 of the first train 48. The shaft 8 of the first machine 6 is connected to the ring gear 48.3 of the first train 48. The shaft 9 of the second machine 7 is connected to a sun gear 49.3 of the second train 49. As a variant, these planetary trains 48 and 49 are connected with each other in a different way, but they always have four degrees of freedom, one for each shaft.

In this embodiment described in more details in the application FR-A-2832357, the mechanical assembly 10 has a first and a second operating mode. In the first operating mode, the shaft 9 is connected to the shaft 4 of the wheels 3 via a first gear 51 and a first wheel 52. This first operating mode is implemented for short transmission ratios. In the second operating mode, the shaft 9 is connected to the sun gear 49.3 of the second train 49 via a second gear 53 and a second wheel 54. This second operating mode is implemented for long transmission ratios.

To ensure the switching from one mode to another, a jaw clutch 50 moves in translation on the shaft 9. Depending on its position on the shaft 9, the jaw clutch 50 drives in rotation, either the first gear 51, or the second gear 53. The shaft 9 can thus always be connected to the element that rotates the slowest between the shaft 9 and the sun gear 49.3. Connecting the shaft 9 to the element that rotates the most slowly makes it possible to limit the power dissipated by the electric chain.

In general, the following transmission equations can be established:
C2=K1*C1+K2*CB (3)
CA=K3*C1 (in the first operating mode) (4)
C1=K4*CA+K5*CB (in the second operating mode) (5)

K1 is a constant linked to the ratios of the first planetary train 48. K2 is a constant linked to gear ratios. K4 and K5 are constants linked to gear ratios and to ratios of the trains 48 and 49.

The equation (3) indicates that the torque C2 applied to the shaft 4 of the wheels 5 is equal to the sum of the torque C1 observable downstream of the flywheel 3.1 and of the torque CB applied to the shaft 9 of the second machine 7, taking into account the multiplying coefficients. The equation (4) indicates that in the first operating mode, the torque CA applied to the shaft 8 of the first machine is proportional to the torque C1. The equation (5) indicates that in the second operating mode, the torque C1 is equal to the sum of the torque CA and of the torque CB, taking into account the multiplying coefficients.

FIG. 3 shows a detailed example of a regulation system implementing the regulation method according to the invention. In this system, a power portion 30 and a control portion 31 are distinguished.

The power portion 30 includes the engine 3, the machines 6 and 7, as well as the inverters 12 and 13 associated therewith. In addition, the power portion 30 has the mechanical assembly 10.

The control portion 31 includes control devices, in particular the regulation device 27 and the regulation modules 28 and 29 studied on FIG. 1. From a pushing down of the acceleration pedal 32, these control devices emit signals that control the various parts of the power portion 30. These parts then supply the necessary power to the vehicle so that it can produce a requested acceleration.

Further, in this regulation system, the electrical regulation chain whose elements are shown with light grey, and the mechanical regulation chain whose elements are not shown with grey, are distinguished. These regulation chains are characterized in particular by their response time.

In the electrical regulation chain, torque signals CA and CB correspond to the torques observable on the two electric machines 6 and 7. These torque signals CA and CB are applied at the input of a first multiplicative cell 34 and of a second multiplicative cell 35, respectively. These multiplicative cells 34 and 35 multiply the value of the torque signal that is applied at the input thereof by a value of rotation speed. Thus, the value of the torque signal CA is multiplied by WA and the value of the torque signal CB is multiplied by WB. A power signal PA and a power signal PB are thus observable at the output of the first multiplicative cell 34 and of the second multiplicative cell 35, respectively. These power signals PA and PB correspond to the electrical power transmitted by the machine 6 and to that transmitted by the machine 7, respectively.

These power signals PA and PB are applied to a first and a second input of an adder 36, respectively. At a third input of this adder 36 is applied a power signal PELEC corresponding to the losses PLOSSES of the electric machines and to a power PBOARD consumed by the on-board network. At the output of this adder 36 is then observable a power signal PCAPA corresponding to the power absorbed by the capacitor 21.

This power signal PCAPA is applied at the input of a cell 37 of transfer function 1/(V′*C*p). V′ corresponds to the voltage observable on the bus 14. C corresponds to the capacity of the capacitor 21. p corresponds to a Laplace operator. By dividing the power PCAPA absorbed by the capacitor 21 by the voltage V′, the current that passes through this capacitor 21 is obtained. In the Laplace domain, the impedance of a capacitor is equal to 1/Cp. Thus, by multiplying the current PCAPA/V′ passing through the capacitor 21 by the impedance 1/(C*p) of this capacitor 21, the voltage signal V observable at the terminals of this capacitor 21 is obtained. This voltage signal V is applied at the input of a cell 38 that multiplies this signal by −1.

The signal obtained at the output of the cell 38 is then applied to a first input of an adder 39. At a second input of this adder 39 is applied the threshold voltage signal RefV that corresponds to the voltage expected at the terminals of the capacitor 21. Thus, the voltage signal V actually observable at the terminals of the capacitor 21 is compared to the threshold voltage signal Vref. An error signal EV is then observable at the output of the comparator 36.

This error signal EV is applied at the input of a first correcting cell 40. This correcting cell 40 is preferably a regulation corrector of the PI, proportional, integral type. At the output of the correcting cell 40, the electrical reference signal RefELEC is obtained. The first regulation module 28 thus has in fact the adder 39 and the correcting cell 40.

As we have seen, the electrical reference signal RefELEC is applied to a first input of the regulation device 27. To the second input of the regulation device 27 is applied the mechanical reference signal RefEMCA to which we will devote our attention a little further below. The regulation device 27 produces the set point signals RefCA and RefCB corresponding to the torques expected on the shafts 8 and 9.

The set point signal RefCA and the set point signal RefCB are applied at the input of a first control cell 41 and of a second control cell 42, respectively. The control cells 41 and 42 produce each three information signals 41.1 and 42.1. The information signals 41.1 and the information signals 42.1 correspond to the voltage signals to be applied to the terminals of the coils of the machine 6 or 7 associated thereto.

The information signals 41.1 and the information signals 42.1 are applied at the input of a first pulse modulating device 43 and of a second pulse modulating device 44. These pulse modulating devices 43 and 44 calculate the instants at which the control signals must be applied to bases of transistors of the inverters 12 and 13 and produce these control signals. These pulse modulating devices 43 and 44 make it possible to vary the time period during which the transistors are conducting, so as to vary the electrical power transmitted by the machines 6 and 7. In practice, the control cells 41 and 42 and the pulse modulating devices 43 and 44 are integrated in a same electronic circuit.

Considered as a whole, the electrical regulation loop has a very short response time, in the order of a hundred microseconds. Further, the response time of couplings 12.1, 13.1 between the inverters 12 and 13 and the pulse modulating devices 42 and 43 is very short, as well as the response time of couplings between the machines 6 and 7 and the control cells 41 and 42. Indeed, these response times are here also in the order of a hundred microseconds.

In the mechanical regulation loop, a signal 32.1 corresponding to a degree of pushing down of the pedal 32 by a user is applied at the input of a pedal law cell 46. As a function of the degree of pushing down of the pedal 32, this pedal law cell 46 produces the reference signal RefC2 that corresponds to the torque expected on the shaft 4 of the wheels 5. Said in another way, the reference signal refC2 is simulated with the help of the pedal law cell 46.

This reference signal RefC2 participates in the control of the engine 3 and in the adjustment of the set point signals RefCA and RefCB. To this effect, the reference signal RefC2 is applied to a first input of a transmission module 47. The reference signal RefC1 is applied to a second input of the transmission module 47.

The transfer function of the transmission module 47 corresponds to the transmission equations of the mechanical assembly 10. Thus, in the transmission module 47, the previously stated transmission equations (3), (4), (5) are entered in the form:
RefC2=K1*RefC1+K2*Ref1CB (3′)
Ref1CA=K3*RefC1 (in the first operating mode) (440 )
RefC1=K4*Ref1CA+K5*Ref1CB (in the second operating mode) (5′)

The values of the reference signals RefC1 and RefC2 and the values of the constants K1-K5 are known. In each mode, two equations can be established. Values of intermediary reference signals Ref1CA and Ref1CB can thus be deduced.

These intermediary reference signals Ref1CA and Ref1CB are applied at the input of a module 56 performing a linear combination of these values of these signals. At the output of this linear combination module 56 is observable the mechanical reference signal RefMECA. The mechanical regulation device 27 then solves the system formed by the equations (1) and (2). In a particular embodiment, this device 27 is a Cramer cell that makes it possible to solve such equations. As a variant, the device 27 is a vectorial cell that performs a vectorial analysis to solve the equations (1) and (2). The second regulation module 29 thus includes the transmission module 47 and the combination module 56.

In summary, in the invention, the reference signals RefC1 and RefC2 are processed and combined with the help of the transmission module 47 and of the combination module 56. After this combination and this processing of the reference signals RefC1 and RefC2, the mechanical reference signal RefMECA is observable at the output of the combination module 56. And to produce the set point signals RefC1 and RefC2, the mechanical reference signal RefMECA is combined with the electrical reference signal RefELEC.

In addition, in the mechanical regulation chain, the reference signal RefC2 is applied at the input of a multiplier module 57. This multiplier module 57 multiplies the value of the reference signal RefC2 by the rotation speed W2 of the shaft 4 of the wheels 5. A power signal P2 is observable at the output of this multiplier module 57. this power signal P2 corresponds to the power transmitted by the shaft 4 of the wheels 5.

This power signal P2 is applied to a first input of an adder 58. To a second input of this adder 58 is applied the power signal PELEC. The adder 58 thus ensures the sum of the power consumed in the mechanical chain and of the power consumed in the electric chain. At the output of this adder 58 is thus observed a reference power signal PMTH. This reference power signal PMTH corresponds to the power that should be supplied by the engine 3 to obtain an acceleration corresponding to the pushing down of the pedal 32.

The reference power signal PMTH of the engine 3 is applied at the input of a first mapping module 59 of the engine. This first mapping module 59 makes it possible, from a given power, to determine the speed of the engine 3 for which the consumption of this engine is minimal. At the output of this module 59 is thus observable a reference signal RefWMTH corresponding to an expected rotation speed of the shaft 2 of the engine 3.

This reference signal RefWMTH is applied to a first input of an adder 60. To a second input of the adder 60 is applied a signal −WMTH. This signal −WMTH corresponds to the signal of the actual rotation speed of the shaft 2 of the engine 3 multiplied by minus one. This multiplication by minus one is performed with the help of a module 64.1. At the output of the adder 60 is observable an error signal EW. This signal EW is applied at the input of a corrector cell 61 that is here also a regulation corrector of the PI, Proportional, Integral type. At the output of this corrector cell 61 is observable a reference torque signal RefCMTH. This reference torque signal RefCMTH corresponds to the expected torque on the shaft 2 of the engine 3.

This reference torque signal RefCMTH is applied at the input of a monitoring module 62 of the heat engine 3. This monitoring module 62 controls in particular the injection of fuel into the engine 3. There is a coupling between the engine 3 and the monitoring module 62. The response time of this coupling is long as compared to the response times observable in the electric chain, in the order of 100 microseconds.

At the output of the module 10, the torque C2 produces the acceleration of the vehicle. A speed W2 corresponding to the rotation speed of the shaft 4 of the wheels 5 results therefrom in the end. This dependence relationship is shown on FIG. 3 by a cell 63 of the known type.

Also at the output of the module 10, the torque C1 defines the charging torque of the heat engine 3. In combination with the engine torque of this heat engine 3, the acceleration of the engine 3, and thus in the end its speed WMTH results therefrom. This dependence relationship is shown on FIG. 3 by a cell 64 of a known type.

The speed WMTH of the heat engine is measured and the signal WMTH is applied at the input of a module 64.1, which multiplies by −1 the values of the signal WMTH. The signal observable at the output of the module 64.1 is applied at the input of a second mapping module 65. For a given rotation speed, this second mapping module 65 determines the torque for which the power consumed by the engine is minimal. At the output of this second mapping module 65 is thus observable the reference torque signal RefC1. This reference torque signal RefC1 is applied to an input of the transmission module 47.

As a variant, the corrector cells 40 and 61 are corrector cells of the derivative type only, or integral only, or proportional, derivative, and integral.

FIG. 4 shows a graphic view of an adjustment of the reference torques expected on the shafts of the machines 6 and 7 with the help of the method according to the invention. In a plane where CA are indicated in abscissa and CB in ordinates, straight lines associated with the electrical reference signal RefELEC and a straight line associated with the mechanical reference signal RefMECA are shown. Since the regulation in the electrical loop is much faster than the regulation in the mechanical loop, WA and WB are considered as constants, as stated above.

During a first processing of the voltage signal V, a first value of electrical reference signal RefELEC1 is produced. For this value of reference signal RefELEC1, the affine straight line having the equation RefELEC1=CA*WA+CB*WB is shown.

With the help of the transmission module, intermediate torque signals Ref1CA and Ref1CB calculated from the reference signals RefC1 and RefC2 are produced. This determination of the intermediary signals Ref1CA and Ref1CB makes it possible to determine a passage point P. Indeed, the coordinates of this point P are the values of these intermediary signals Ref1CA and Ref1CB.

In accordance with the invention, the regulation device 27 produces an affine straight line having the equation RefMECA=CA*WGB−CB*WA. The straight line associated with RefMECA thus passes through the passage point P. The straight line associated with RefMECA has a slope that makes it perpendicular to the straight line associated with RefELEC1.

The intersection of the straight line associated with the electrical reference RefELEC1 and of the straight line associated with the mechanical reference RefMECA is a point I. The coordinates of this point I correspond to the values of the reference signals RefCA and RefCB to be applied at the input of the control cells 41 and 42. This method makes it thus possible to determine precisely the point whose coordinates verify the two equations (1) and (2) among the candidate points on the straight line of RefELEC.

The electrical regulation loop makes it possible to adjust the values produced by the mechanical regulation loop. Indeed, the intersection of the two straight lines displaces the point P stemming from a simulation toward the point I.

During a second processing of the voltage signal V, the value of the electrical reference signal RefELEC changes and becomes RefELEC2. The straight line associated with RefELEC2 is here parallel to the straight line associated with RefELEC1. Indeed, it is considered that between the two processing operations of the voltage signal V, the rotation speeds WA and WB of the shafts of the machines are unchanged. The intersection point corresponding to the values of the torque signals RefCA and RefCB thus moves to I′. The fact that the straight lines associated with RefMECA and RefELEC are perpendicular makes it possible to limit discrepancies of set point values between two successive processing operations.

Of course, in the general case, the slopes of the two straight lines associated with RefELEC and to RefMECA can take any value. The point I can be anywhere in the plane (CA, CB) and the straight lines associated with RefELEC and to RefMECA can perform a rotation of 360 degrees in this plane.

1. Regulation method for a power transmission device between a shaft of a heat engine and a shaft of wheels, this method implementing
two electric machines, a first machine having a shaft rotation speed WA and a torque CA, a second machine having a shaft rotation speed WB and a torque CB,
a mechanical assembly connecting the shaft of the wheels, the shaft of the engine, and the shafts of the two electric machines with one another,
a connecting device ensuring a direct passage from an electrical power between the two machines,
the connection device having an electrical regulation device producing set point signal RefCA and RefCB intended to be followed by the machines,
said method comprising:
producing an electrical reference signal RefELEC corresponding to CA*WA+CB*WB and applying it to a first input of the electrical regulation device, and
producing a mechanical reference signal RefMECA corresponding to CA*WB−CB*WA and applying it to a second input of the electrical regulation device, and
with the regulation device, producing set point signals RefCA and RefCB by linear combination of the electrical reference signal RefELEC and the mechanical reference signal RefMECA.

2. Method according to claim 1 comprising, to produce the set point signals RefCA and RefCGB:
solving with a Cramer cell two equations equal to RefELEC and RefMECA, respectively, with coefficients equals to WA and WB, and
producing solution variables equal to RefCA and RefCB.

3. Method according to claim 1 comprising, to produce the mechanical reference signal RefMECA:
producing a reference signal RefC1 that corresponds to the torque that is expected on the shaft of the engine,
producing by simulation a reference signal RefC2 that corresponds to the torque that is expected on the shaft of the wheels, and
applying the reference signal RefC1 and the reference signal RefC2 to inputs of a solver cell,
wherein a transfer function of the solver cell corresponds to transmission determining equations of the transmission device,
producing with the help of this solver cell the intermediary reference signals Ref1CA and Ref1CB,
applying the intermediary reference signals Ref1CA and Ref1CB to the inputs of a combination cell that performs a linear combination of the values of the signals that are applied to its input, and
producing at the output of this combination cell the signal RefMECA.

4. Method according to claim 3, wherein
the reference torque C1 corresponds to the torque that is expected on the shaft of the engine downstream of an flywheel connected to this shaft.

5. Method according to claim 1, comprising, to produce the electrical reference signal RefELEC:
measuring a voltage signal V at the terminals of the storage device,
performing the difference between this measured voltage signal V and a set point signal Vref and obtaining an error signal EV,
applying this error signal EV at the input of a correcting cell, and
producing the electrical reference signal RefELEC with the help of this correcting cell.

6. Method according to claim 5, wherein the correcting cell is of the proportional integral type.

7. Method according to claim 1, comprising:
transmitting the set point signals RefCA and RefCB via transmitting devices, and
connecting the transmitting devices with each other via an electrical connection.

8. Method according to claim 7, comprising:
placing on the electrical connection a low-capacity storage device.

9. Method according to claim 8 wherein
the low-capacity storage device is a capacitor.

10. Method according to claim 7, wherein
the transmitting devices are inverters and the electrical connection is a direct current bus.
